(19) United States
(12) Patent Application Publication
(10) Pub. No.: US 2005/0168937 A1
(43) Pub. Date: Aug. 4, 2005

(54) Combination computer battery pack and port replicator

(76) Inventors: Memphis Zhihong Yin, Tomball, TX (US); Paul Doczy, Cypress, TX (US); Ron DeLuga, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/769,366

(22) Filed: Jan. 30, 2004

(51) Int. Cl. G06F 1/16

(52) U.S. Cl. 361/686

(57) ABSTRACT

An accessory for a computer provides both an auxiliary battery and a port replicator in an integrated unit. In one embodiment, the accessory includes a docking connector, a battery, and at least one communication port, with the battery and communication port connected to the docking connector so that power from the battery and communication signals to the communication port can pass through the docking connector.

### FIELD OF THE INVENTION

The present invention relates generally to portable computers.

### BACKGROUND OF THE INVENTION

Portable computers are increasingly popular among mobile professionals. Often, when a user of a portable computer is away from an office, the computer is used in a standalone configuration, with few or no peripheral devices attached. In keeping with this kind of use, a portable computer often has few connection ports available for connecting peripheral devices. During such out-of-office use, the computer typically runs on battery power, and battery capacity is an ongoing limitation on the usefulness of the computer, especially on how long the computer can be used before recharging. Auxiliary external batteries are available for some computers so that the out-of-office working time can be extended.

Peripheral devices are increasingly being developed for portability as well. For example, battery-powered printers are now available. Some peripheral interfaces such as the Universal Serial Bus (USB) and the IEEE (Institute of Electrical and Electronics Engineers) 1394 “Firewire” interface enable a peripheral device to draw its operating power from the interface itself, thus eliminating the need for a separate power connection to the peripheral device. For example, USB-powered digital cameras, scanners, and mass storage devices are already available.

A computer user may wish to use several peripheral devices while out of the office, but may be hindered by two problems. First, the user may be limited by the number of connection ports available on the computer. Second, if the peripheral devices are powered over their communication interfaces, the peripherals draw their power from the computer batteries, thus exacerbating the problem of limited battery capacity.

Often, for in-office use, the computer is plugged into a docking station, or port replicator. Typically, a docking station provides power from a wall socket for recharging the computer batteries, and may also provide additional connection ports for peripheral devices. While a docking station provides a convenient way to use a portable computer in an office setting, docking stations may be awkward to transport, and do not address the problem of limited battery capacity when the computer is used away from an office.

### SUMMARY OF THE INVENTION

Embodiments of an accessory for a computer provide both an auxiliary battery and a port replicator in an integrated unit. In one embodiment, the accessory comprises a docking connector, a battery, and at least one communication port, with the battery and communication port connected to the docking connector so that power from the battery and communication signals to the communication port can pass through the docking connector.

### BRIEF DESCRIPTION OF THE DRAWINGS

FIG. 1 shows a computer accessory in accordance with an example embodiment of the invention, poised to connect to a portable computer.

FIG. 2 shows the computer accessory of FIG. 1, connected to a portable computer.

FIG. 3 shows a cutaway perspective view of the interaction of hook features, receiving features, and release pins for attaching the accessory of FIG. 1 to a portable computer.

FIG. 4 schematically shows an exemplary way connections inside the computer accessory of FIG. 1 may be made, and their interactions with example internal components of a computer.

FIG. 5 depicts a computer accessory in accordance with another example embodiment of the invention.

### DETAILED DESCRIPTION

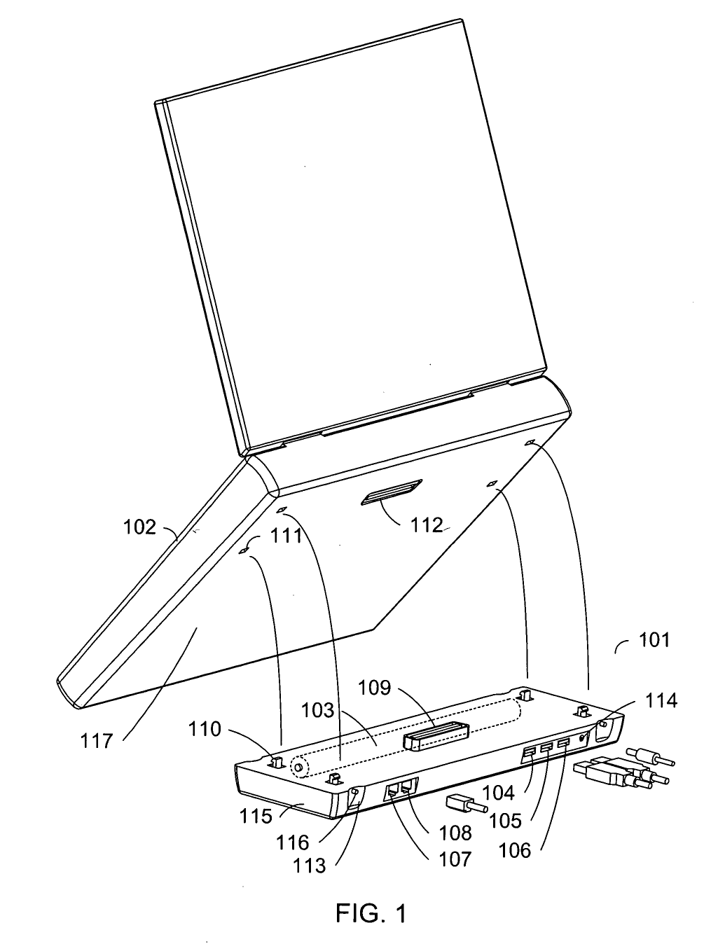

FIG. 1 shows a computer accessory 101 in accordance with an example embodiment of the invention, poised to attach to a portable computer 102. Computer accessory 101 comprises an internal battery 103, schematically shown in broken lines. Battery 103 is preferably a rechargeable battery, is made up of at least one cell, and may be of a shape different than the generally cylindrical shape shown in FIG. 1. Wiring connections inside computer accessory 101 are omitted in this view for clarity.

Computer accessory 101 also comprises at least one communication port. By way of illustration, the computer accessory shown in FIG. 1 includes three Universal Serial Bus (USB) ports 104, 105, and 106, a modem port 107, and a local area network (LAN) connection 108. Other combinations of communication ports could be used. For example, more or fewer USB, LAN, or modem ports could be included than are shown in FIG. 1, or other kinds of ports could be included, such as one or more RS-232 (Recommended Standard 232) serial ports, IEEE 1284 parallel ports, IEEE 1394 “Firewire” serial ports, Small Computer System Interface (SCSI) ports, or other kinds of data communication interfaces. Communication ports may be located on other faces of computer accessory 101 instead of or in addition to the face shown in FIG. 1. Computer 102 is shown in FIG. 1 in an idealized fashion for simplicity of explanation. An actual computer used with computer accessory 101 may also comprise communication ports.

In one example arrangement, the communication ports on computer accessory 101 replicate ports on computer 102. Computer accessory 101 then comprises a port replicator, and also comprises an auxiliary battery for computer 102, the port replicator and the auxiliary battery being integrated into a single unit. Computer accessory 101 need not comprise the same number of communication ports as the computer it is connected to comprises.

Computer accessory 101 also includes a docking connector 109. Docking connector 109 has multiple contact points so that it can carry multiple independent signals. In this example embodiment, docking connector 109 has contacts for transmitting power from battery 103, and contacts for carrying communication signals between computer 102 and the communication ports. Docking connector 109 may be of a standard type available in the industry, or may be specifically designed for this application.

Computer accessory 101 also comprises housing 115.

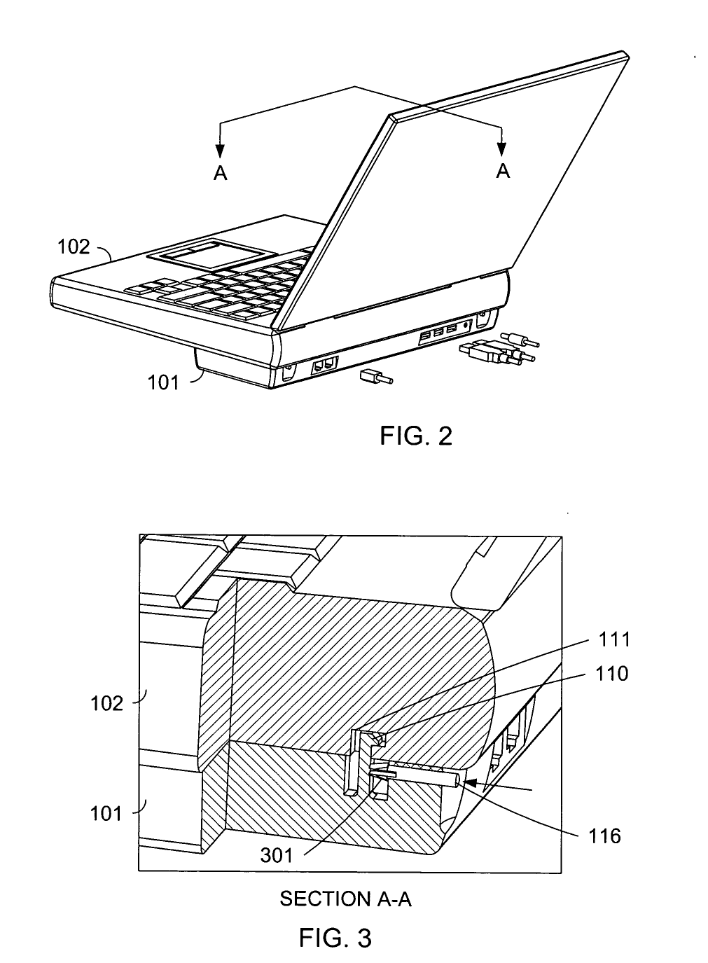

In the example embodiment shown in FIG. 1, computer accessory 101 mechanically attaches to the bottom of portable computer 102 using hook features 110. Hook features 110 engage receiving features 111 on portable computer 102. In the process, docking connector 109 engages mating connector 112, making an electrical connection between computer accessory 101 and portable connector 102. Mating connector 112 has contacts complementary to the contacts on docking connector 109, and enables computer accessory 101 to exchange signals with portable computer 102. FIG. 2 shows computer accessory 101 attached to the bottom 117 of portable computer 102. Computer accessory 101 could also be attached to a different face of portable computer 102, or could attach in a way that involves more than one face of portable computer 102.

The computer user can disengage computer accessory 101 from computer 102 without the use of tools by grasping grip recesses 113, depressing release pins 116, and pulling accessory 101 away from computer 102. Other kinds of features may be used to attach and detach accessory 101 to and from computer 102.

FIG. 3 shows a cutaway perspective view of the interaction of hook features 110, receiving features 111, and release pins 116. The view shown is taken along section A-A in FIG. 2. Hook feature 110 snaps into undercut receiving feature 111, holding accessory 101 against the bottom of portable computer 102. Release pin 116 has been snapped into its channel and is restrained there by a raised feature 301 at its forward end. The computer user can actuate release pin 116 in the direction shown by pressing on its rearward end, forcing it against hook feature 110 so as to release hook feature 110 from receiving feature 111. The other hook and receiving features shown in FIG. 1 operate similarly. Thus release pins 116 provide a releasing mechanism for detaching computer accessory 101 from portable computer 102. Computer accessory 101 and computer 102 may have more or fewer sets of attaching and releasing features than are depicted in the Figures.

Example computer accessory 101 also includes a power receptacle 114 for receiving power from an external source, such as, for example, a mains power outlet. A mains power outlet is one connected to the widely available power grid, often through a standard wall socket. In the United States, mains power is typically alternating current (AC), supplied at about 110 volts with a nominal frequency of 60 hertz. Some other countries use other voltages and frequencies, and other voltages are sometimes available in the United States as well. For the purposes of this disclosure, a mains power outlet includes all of these variations and their equivalents. Receiving power from a mains power outlet also includes receiving power through a transformer or conditioning device connected to a mains power outlet. For example, many small electronic devices receive power from a small transformer designed to plug into a mains power outlet and supply AC power to the device at a reduced voltage, or to supply direct current (DC) power, also typically at a reduced voltage.

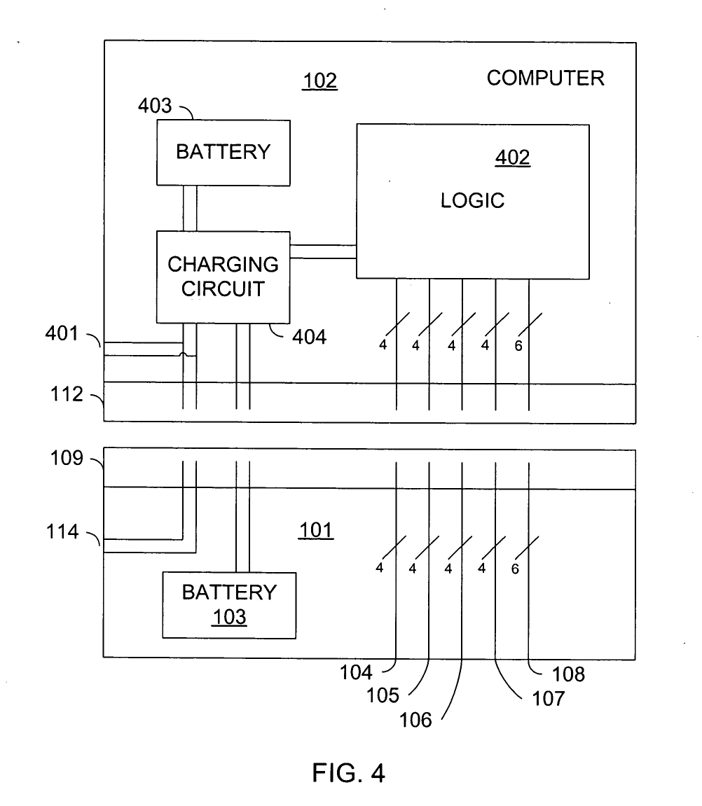

FIG. 4 schematically shows how the connections inside computer accessory 101 may be made, and their interactions with example internal components of computer 102. In this example embodiment, connections pass through computer accessory 101, between docking connector 109 and mating connector 112, to computer circuitry 402. Computer circuitry 402 includes sufficient electrical contacts to service all of the communication ports. When docking connector 109 and mating connector 112 are engaged, battery 103 is connected with a charging circuit 404 inside computer 102. Charging circuit 404 is also connected to the computer's internal battery 403. Charging circuit 404, re-charges both batteries if external power is available, and/or manages the use of power from the two batteries when the system is running on battery power. Power receptacle 114 is connected in parallel with a similar power receptacle 401 on computer 102. Numerous alternative connection arrangements are possible. For example, computer accessory 101 could contain a USB hub, a device that enables the connection of several USB devices to a computer with only one USB port. In that case, docking connector 109 and mating connector 112 could comprise fewer contacts.

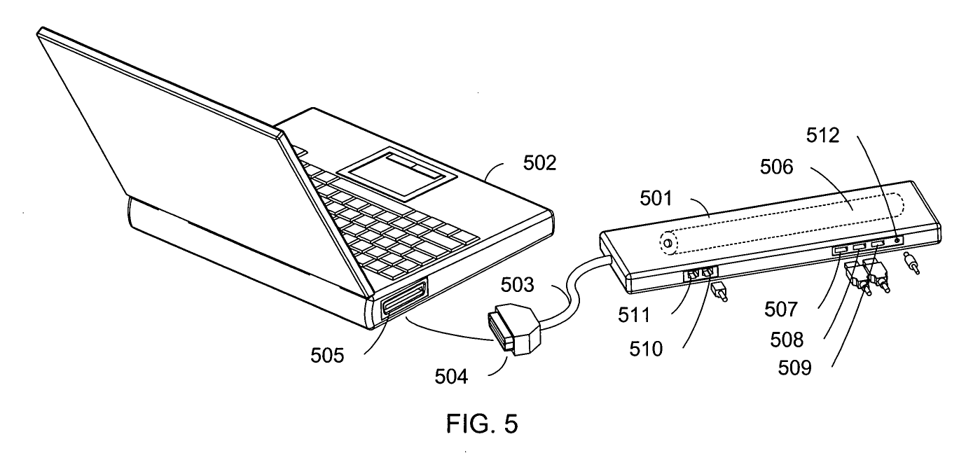

FIG. 5 depicts a computer accessory 501 in accordance with another example embodiment of the invention. In this example embodiment, accessory 501 connects to a portable computer 502 through a cable 503 that emanates from computer accessory 501. A docking connector 504 at the end of cable 503 engages mating connector 505. Computer accessory 501 comprises a battery 506, shown in broken lines, and at least one communication port. The example computer accessory shown in FIG. 5 includes three USB ports 577, 508, and 509, as well as a modem port 510 and a LAN connection port 511. Example computer accessory 501 also includes an external power connection 512. Of course, other combinations of port connections are possible, and the port connections may be positioned differently on computer accessory 501 than is shown in FIG. 5.

1. A computer accessory, comprising:
an auxiliary battery; and
a port replicator;
the auxiliary battery and the port replicator integrated into a single unit.

2. A computer accessory, comprising:
a docking connector;
a battery;
at least one communication port;
a connection from the docking connector to the battery; and
a connection from the docking connector to the communication port;
the battery powering a computer connected to the docking connector.

3. The computer accessory of claim 2, wherein the docking connector is configured to engage a mating connector on the computer.

4. The computer accessory of claim 2, further comprising a housing configured to attach to the computer.

5. The computer accessory of claim 2, wherein the computer accessory is configured to attach to the bottom of the computer.

6. The computer accessory of claim 2, further comprising at least one hook feature, configured to engage a receiving feature on the portable computer.

7. The computer accessory of claim 2, further comprising a releasing mechanism which, when actuated, disengages computer accessory from the computer.

8. The computer accessory of claim 2, wherein the computer accessory can be attached to and detached from the computer without the use of tools.

9. The computer accessory of claim 2, wherein the docking connector connects to the computer through a cable.

10. The computer accessory of claim 2, further comprising a receptacle for accepting power from an external power source.

11. The computer accessory of claim 10 wherein the external power source is a source of mains power.

12. The computer accessory of claim 10, wherein the power received from the external source can be used to recharge the battery.

13. The computer accessory of claim 2 wherein the at least one communication port includes at least one Universal Serial Bus port.

14. A system, comprising the computer-accessory of claim 2 connected to a computer.

15. The system of claim 14, wherein the computer accessory is attached to the computer.

16. The system of claim 15, wherein the computer accessory is attached to the bottom of the computer.

17. The system of claim 14 wherein the computer is a portable computer.

18. The system of claim 14, wherein the computer accessory is connected to the computer through a cable.

19. A computer accessory, comprising:
means for making an electrical connection between the computer accessory and a computer;
means for supplying electrical energy to the computer, from a battery comprised in the computer accessory, through the electrical connecting means; and
means for connecting the computer to at least one peripheral device through the electrical connection means.

20. The computer accessory of claim 18, further comprising means for mechanically attaching the computer accessory to the portable computer.
